(19) United States
(12) Patent Application Publication
(10) Pub. No.: US 2003/0108042 A1
(43) Pub. Date: Jun. 12, 2003

(54) Characterizing network traffic from packet parameters

(76) Inventors: David Skillicorn, Kingston (CA); Gaoyuan Zhang, Burnaby (CA)

Correspondence Address: Stikeman Elliott, Derenyi Eugene, 1600-50 O'Connor Street, Ottawa, ON, K1P 6-L2, CA

(21) Appl. No.: 10/275,214

(22) PCT Filed: May 3, 2001
(86) PCT No.: PCT/CA01/00596

(30) Foreign Application Priority Data
Jul. 14, 2000 (CA) 2,313,908

(51) Int. Cl. H04L 12/56; H04L 12/28; G06F 15/173

(52) U.S. Cl. 370/389; 709/224

(57) ABSTRACT

Known techniques for characterizing network traffic are based on comparing new traffic with lists of older, known traffic. Performance degrades when such lists are long, as they are in Internet applications. Furthermore, the comparison process often requests a database lookup and hence must take place at the application level. In contrast, a technique is presented that uses geometric regions in a low-dimensional space to characterize network traffic. A packet of new traffic is classified by mapping of the header of the packet to a point in the low-dimensional space and performing a comparison of the point to the geometric regions. Comparison is cheap, and can be carried out in the protocol layer. The approach can be applied to intrusion and novelty detection and to automatic quality of service or content determination.

### FIELD OF THE INVENTION

The present invention relates to packet communication networks and, in particular, to the use of packet parameters to characterize network traffic.

### BACKGROUND OF THE INVENTION

Computer sites connected to the Internet are visible to many different users. These users interact with the computer sites while based in locations having a wide geographic distribution. The sites face a problem in attempting to discriminate between those interactions that should be given priority, those interactions that should not and those interactions that are best ignored completely (e.g., a denial of service attack). It is therefore useful to be able to characterize arriving network traffic as accurately and as quickly as possible.

Traffic characterization (or classification) can be an important tool in intrusion detection, novelty and trend detection, providing appropriate quality of service and providing customized content. Intrusion detection relates to the discovery of network traffic that represents an attempt to try and break into computer systems attached to a particular subnet. For example, an appropriately configured intrusion detection function of a traffic characterization system should be able to recognize the receipt of an abnormal packet and trigger an alarm or otherwise alert a human. Novelty and trend detection relates to detecting when incoming network traffic has never been seen before or when patterns of incoming network traffic are changing. For example, an appropriately configured novelty and trend detection function of a traffic characterization system should be able to identify traffic representative of customers from previously unknown locations. It may be also useful to provide better resources to some network traffic and worse resources to others. For example, an appropriately configured quality of service provision function of a traffic characterization system may provide good response times for customers who have made previous purchases, compared to first time visitors. Furthermore, it may be useful to deliver content based on some broad or precise prediction about the context in which the network traffic originates. For example, an appropriately configured customized content provision function of a traffic characterization system might allow for advertisements to be placed in served web pages, targeted to classes of users, or even individuals. For exemplary customized content provision consider the products of BroadVision Inc. of Redwood City, Calif.

Ideally, responses to incoming traffic are made on tight deadlines. The faster each packet can be classified, the better, since an appropriate response can be made sooner. In particular, the amount of information required to classify each packet can impact performance of a traffic classification system.

One existing technique for traffic characterization characterizes new traffic by comparing it to traffic with known characteristics. The closeness between known traffic and unknown traffic is compared. Computing closeness, even for a single pair of points, is computationally expensive in a high-dimensional space. Because the descriptions of known traffic are large, they cannot be practically stored in a simple data structure, but must be retrieved from a database. This can take a long time, and can only be carried out from within a user-level process.

Often, existing techniques for traffic characterization require consideration of the content of an incoming packet in order to identify the characteristics of the incoming packet. For example, such a traffic classification system may check for the presence of a cookie in the payload of the incoming packet. Unfortunately, the information for characterizing incoming traffic is not available to the traffic classification system until the incoming packet has exited the protocol layer.

### SUMMARY OF THE INVENTION

In contrast to existing techniques for traffic classification, the techniques presented herein use geometric regions to characterize incoming traffic based on packet parameters, such as may be found in packet headers. Advantageously, the computation that determines a classification for each packet requires relatively simple operations on a small data set. Furthermore, since the classification can be based on packet headers, the entire process can take place within the protocol layer (e.g., the Transport Control Protocol layer) rather than requiring an up-call to a full-fledged process.

According to the invention, a novel process is provided that uses geometric regions in a low dimensional space to characterize network traffic. Classification can be carried out in a protocol layer. The approach can be applied to novelty detection and to automatic quality of service or content determination.

In accordance with an aspect of the present invention there is provided a method to facilitate classification of packetized traffic. The method includes considering at least a portion of a header of each of a training set of packets as an m-dimensional vector and reversibly transforming each m-dimensional vector to a r-dimensional vector, where r≦m, and where an element of a given r-dimensional vector having a lower element number is more significant in differentiating the given r-dimensional vector from other r-dimensional vectors obtained from the training set than an element associated with a higher element number of the given r-dimensional vector such that the given r-dimensional vector is substantially defined with respect to the other r-dimensional vectors by its first k elements. In another aspect of the present invention, a traffic classification system is provided for performing this method. In a further aspect of the present invention, there is provided a software medium that permits a general purpose computer to carry out this method.

In accordance with another aspect of the present invention there is provided a method of classifying a received packet. The method includes considering at least a portion of a header of the received packet as a received m-dimensional vector, reversibly transforming the received m-dimensional vector to a received r-dimensional vector, creating a received k-dimensional vector from the first k elements of each received r-dimensional vector and determining whether the received k-dimensional vector is within a first predefined k-dimensional region. In another aspect of the present invention, a traffic classification system is provided for performing this method. In a further aspect of the present invention, there is provided a software medium that permits a general purpose computer to carry out this method.

In accordance with a further aspect of the present invention there is provided a method of classifying a received packet. The method includes considering at least a portion of a header of the received packet as a received m-dimensional vector, transforming the received m-dimensional vector to a received k-dimensional vector, determining whether the received k-dimensional vector is within an existing predefined k-dimensional region and, if the received k-dimensional vector is within a first predefined k-dimensional region, incrementing a first counter, the first counter associated with the first predefined k-dimensional region. In another aspect of the present invention, a traffic classification system is provided for performing this method. In a further aspect of the present invention, there is provided a software medium that permits a general purpose computer to carry out this method.

In accordance with a still further aspect of the present invention there is provided a traffic classification system. The traffic classification system includes a singular value decomposition calculator for transforming a matrix A of training data, which has been classified to result in training data classifications, into component matrices U, Σ and V. The traffic classification system also includes a boundary generator for, given the matrix U and the training data classifications, generating a boundary in a k-dimensional space, a geometric querier for, given the matrices Σ and V and received packet parameters, generating a point in the k-dimensional space and a detector for determining whether the point in the k-dimensional space is inside the boundary in the k-dimensional space and indicating a result of the determining. In a further aspect of the present invention, there is provided a software medium that provides computer-executable instructions to a traffic classification system.

In accordance with an even further aspect of the present invention there is provided a device for facilitating classification of traffic. The device includes a memory for storing a training set of packets and a processor, coupled to said memory, for considering at least a portion of a header of each of said training set of packets as an m-dimensional vector and reversibly transforming each said m-dimensional vector to a r-dimensional vector, where r≦m, and where an element of a given r-dimensional vector having a lower element number is more significant in differentiating said given r-dimensional vector from other r-dimensional vectors obtained from said training set than an element associated with a higher element number of said given r-dimensional vector such that said given r-dimensional vector is substantially defined with respect to said other r-dimensional vectors by its first k elements.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 illustrates a typical network for use with an embodiment of the present invention;

FIG. 2 illustrates a representation of three dimensional rows of a matrix U as points in three dimensional space;

FIG. 3 illustrates steps of a geometric region determining method according to an embodiment of the present invention;

FIG. 4 illustrates steps of a geometric region updating method according to an embodiment of the present invention;

FIG. 5 illustrates steps of a traffic classification method according to an embodiment of the present invention;

FIG. 6 illustrates steps of an alternative traffic classification method according to an embodiment of the present invention;

FIG. 7 illustrates a generic novelty detector according to an embodiment of the present invention; and

FIG. 8 illustrates steps of a staged traffic classification method according to an embodiment of the present invention.

### DETAILED DESCRIPTION

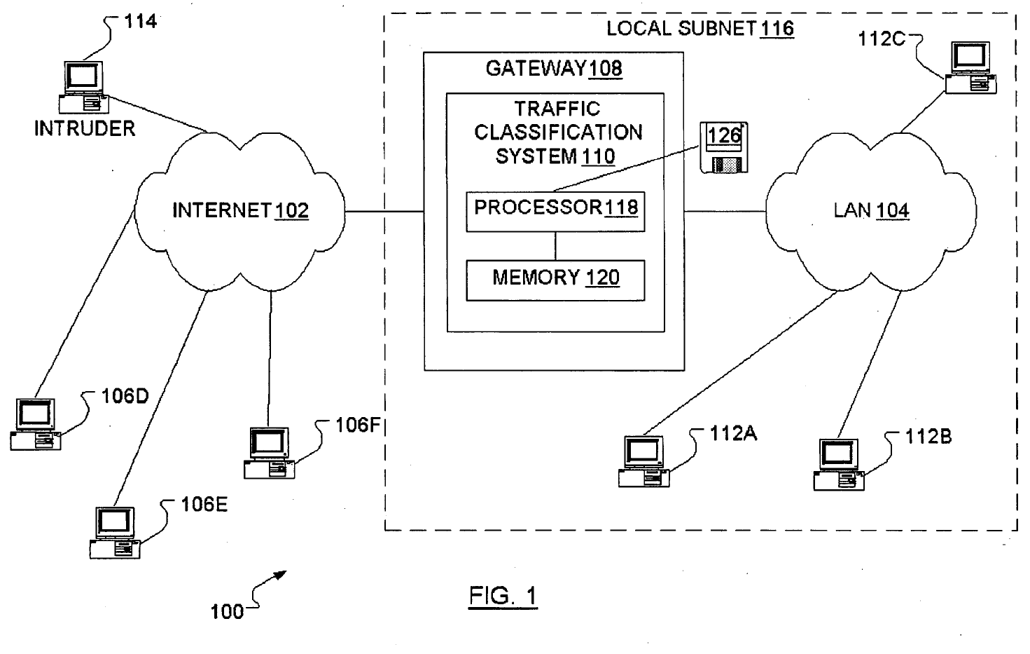

FIG. 1 illustrates a typical network 100 in which the present invention may find use. A local subnet 116 includes a local area network (LAN) 104 to which a number of local traffic sources and sinks 112A, 112B, 112C connect to communicate with each other. The local traffic sources and sinks 112A, 112B, 112C also communicate, via a gateway 108 and a wide area network such as the Internet 102, with remote traffic sources and sinks 106D, 106E, 106F. A traffic classification system 110 may be included in the gateway 108. Use of the traffic classification system 110 may help in minimizing the impact of an attack on the local subnet 116 based at an intruder computer 114. The traffic classification system 110 may include a processor 118 and a memory 120. The processor 118 may be loaded with traffic classification software for executing methods exemplary of this invention from a software medium 126, which may be a disk, a tape, a chip or a random access memory containing a file downloaded from a remote source.

As will be apparent to a person skilled in the art, the traffic classification system 110 may be implemented in hardware, for instance, as a field programmable gate array. Furthermore, use of the traffic classification system 110 is not limited to the exemplary gateway 108. Subject to processing capabilities, the traffic classification system 110 may be included in a router, a network bridge or other network element.

The communication between various traffic sources and sinks, whether local or remote, may use a packet based protocol, such as the widely used Internet Protocol (IP). IP traffic is exchanged in packets of data, where a typical packet has a payload portion, containing the data, and a header portion providing information about the data. For instance, information about the data may include the source and destination of the data.

In overview, classification of traffic is facilitated by considering packet headers of a training set of packets as individual m-dimensional vectors. The m-dimensional vectors are then reversibly transformed into r-dimensional vectors. The transformation results in r-dimensional vectors that are substantially defined, relative to each other, by their first k elements. This transformation can be said to be a mapping of the m-dimensional vectors from m-space into k-space. Where packets of the training set are associated with particular classes of traffic, geometric regions that are representative of each of the classes of traffic may be created in k-space. A given newly received packet may then be classified by transforming the header of the given newly received packet from m-space into k-space and predicting a class for the given newly received packet by proximity to, or enclosure within, a geometric region representative of a particular class. Predicting a class for a packet allows appropriate packet handling. For example, class prediction may allow the traffic classification system 110 to detect and eventually block traffic from the intruder computer 114.

Considering Packet Headers of a Training Set

One embodiment of the present invention requires a training set of network packet headers whose classification is known. For example, in a security application, the training set may include a set of packet headers from normal traffic and a set of packet headers from traffic known to be related to intrusions. For an e-commerce server, the training set might include a set of headers divided into those headers associated with traffic from big spending customers and those headers associated with traffic from ordinary customers. In any case, each packet header may be assigned a class label from a set of desired classifications.

Typical Internet Protocol (IP) packet headers are 64 bits in size. Each bit is either a one or a zero and sets of these bits represent, among other things, source IP address, destination IP address, port number, protocol version number and a checksum. A subset of these bits may be discarded and other sets of these bits mapped to smaller sets to reduce the range of possible values incoming headers may take. Different bits may also be given different weights to reflect hypotheses about their individual contribution to discriminating among the classes.

Each packet in the training set may then be represented by a vector of m (<64) elements and may be regarded as a point in a high-dimensional (m-dimensional) space. According to an embodiment of the present invention, each of these points is subsequently mapped to a point in a space of much lower dimension (say, two, three or four dimensions). This mapping may be performed using Singular Value Decomposition (SVD). For a more complete discussion of SVD, see G. H. Golub and C. F. van Loan, Matrix Computations, Johns Hopkins University Press, 3rd edition, 1996, hereby incorporated herein by reference. SVD has been used extensively in information retrieval applications and for choosing objects in object-oriented program code. It is known that SVD can capture the relationships between objects and then effectively represent the relationships as distances between points in a low-dimensional space.

If the number of classified packets in the training set is n then the input data for an SVD operation can be regarded as an n-by-m matrix, A. Each row in A can be regarded as representing one packet and each column in A can be regarded as representing a bit position in the packet headers. As mentioned briefly above, different bits may also be given different weights. These weights may be reflected in the bit positions. Additionally, if necessary, the values in each column of A may be normalized.

The singular value decomposition of a matrix A allows the matrix A to be expressed as a product of three matrices, U (n-by-r), Σ (r-by-r), and V (r-by-m) where r is the rank of the matrix A. The rank, r, of a matrix may be defined as the number of linearly independent rows (or columns) that the matrix has. Typically, r=min(m, n). The matrix Σ is a diagonal matrix whose diagonal entries (the so-called singular values) are ordered in order of descending magnitude (so that the largest valued element is σ₁ and the smallest valued element is σᵣ). Matrices U and V are orthonormal. A set of vectors is said to be an orthonormal set if every pair of vectors is orthogonal and every vector is a unit vector. The decomposition is shown below.

$$A = U ΣV [ \begin{matrix}{a}_{11} & ⋯ & ⋯ & ⋯ & {a}_{1 m} \\ ⋮ & & & & ⋮ \\ ⋮ & & & & ⋮ \\ ⋮ & & & & ⋮ \\ ⋮ & & & & ⋮ \\ ⋮ & & & & ⋮ \\ {a}_{n1} & ⋯ & ⋯ & ⋯ & {a}_{nm}\end{matrix} ] = [ \begin{matrix}{u}_{11} & ⋯ & ⋯ & {u}_{1 r} \\ ⋮ & & & ⋮ \\ ⋮ & & & ⋮ \\ ⋮ & & & ⋮ \\ ⋮ & & & ⋮ \\ ⋮ & & & ⋮ \\ {u}_{n1} & ⋯ & ⋯ & {u}_{nr}\end{matrix} ] [ \begin{matrix}{σ}_{1} & ⋯ & ⋯ & 0 \\ ⋮ & ⋰ & ⋱ & ⋮ \\ ⋮ & ⋰ & ⋱ & ⋮ \\ 0 & ⋯ & ⋯ & {σ}_{r}\end{matrix} ] [ \begin{matrix}{v}_{11} & ⋯ & ⋯ & ⋯ & {v}_{1 m} \\ ⋮ & & & & ⋮ \\ ⋮ & & & & ⋮ \\ {v}_{r1} & ⋯ & ⋯ & ⋯ & {v}_{rm}\end{matrix} ] \\$$

The rows of the matrix U can be regarded as r-dimensional representations of the rows of A. We may select a k<r and consider only the first k columns of U. Each of the rows of the matrix formed from the first k columns of U can be regarded as points in a k-dimensional space. In practice, k is chosen to be fairly small. The magnitude of the singular values, i.e., the σᵢ values in the matrix Σ, represent the amount of variation in the original data (matrix A) captured by each column (and hence each dimension) of the matrix U. Notably, the singular values are monotonically decreasing, i.e., σ₁≧σ₂≧ . . . ≧σᵣ≧0.

Computing the singular value decomposition of a matrix provides a mapping from m-dimensional space to k-dimensional space while preserving the best approximation of the region of the higher-dimensional space. Furthermore, the difference between the magnitude of the k^{th} and (k+1)^{th} singular values (σₖ and σ₍ₖ₊1)) provides some information about how much structure is being lost by ignoring further dimensions.

### EXAMPLE

By way of example, consider the following matrix A of 7-bit packet headers:

$$A = [ \begin{matrix}1 & 0 & 1 & 1 & 0 & 0 & 1 \\ 0 & 0 & 1 & 1 & 0 & 1 & 1 \\ 0 & 1 & 0 & 1 & 1 & 0 & 1 \\ 0 & 0 & 0 & 1 & 1 & 1 & 1 \\ 0 & 1 & 0 & 1 & 0 & 1 & 1 \\ 1 & 0 & 0 & 1 & 1 & 0 & 1 \\ 0 & 1 & 1 & 1 & 0 & 0 & 1 \\ 0 & 1 & 0 & 1 & 0 & 1 & 1 \\ 1 & 1 & 1 & 0 & 0 & 1 & 0 \\ 1 & 1 & 0 & 0 & 1 & 1 & 0 \\ 1 & 1 & 1 & 0 & 1 & 0 & 0\end{matrix} ]$$

The first eight rows of A represent one class of traffic (perhaps normal traffic) and the remaining three rows of A represent another class of traffic (perhaps intrusions). The values in each column could be normalized but, in this case, each header has the same number of 0 and 1 bits and the column sums are approximately equal. We may therefore use this data directly.

Applying SVD, we obtain matrices U, Σ and V. In particular, the matrix Σ takes the following form:

$$Σ = [ \begin{matrix}5.1441 & 0.0 & 0.0 & 0.0 & 0.0 & 0.0 & 0.0 \\ 0.0 & 2.5573 & 0.0 & 0.0 & 0.0 & 0.0 & 0.0 \\ 0.0 & 0.0 & 2.0 & 0.0 & 0.0 & 0.0 & 0.0 \\ 0.0 & 0.0 & 0.0 & 1.9743 & 0.0 & 0.0 & 0.0 \\ 0.0 & 0.0 & 0.0 & 0.0 & 1.5038 & 0.0 & 0.0 \\ 0.0 & 0.0 & 0.0 & 0.0 & 0.0 & 0.91599 & 0.0 \\ 0.0 & 0.0 & 0.0 & 0.0 & 0.0 & 0.0 & 2.6438 e - 16\end{matrix} ]$$

From an examination of the singular values, σᵢ, a decision may be made to select only the first three (k) columns of U such that the matrix Uₖ takes the following form:

$${U}_{k} = [ \begin{matrix}0.29738 & 0.021768 & - 0.35355 \\ 0.31551 & 0.23698 & - 0.35355 \\ 0.32516 & 0.11161 & 0.35355 \\ 0.31551 & 0.23698 & 0.35355 \\ 0.3398 & 0.20394 & - 1.2602 e - 16 \\ 0.29738 & 0.021768 & 0.35355 \\ 0.32516 & 0.11161 & - 0.35355 \\ 0.3398 & 0.20394 & 7.8904 e - 17 \\ 0.25085 & - 0.47682 & - 0.35355 \\ 0.25085 & - 0.47682 & 0.35355 \\ 0.23622 & - 0.56914 & - 5.2411 e - 17\end{matrix} ]$$

and Vₖ takes the form:

$${V}_{k} = [ \begin{matrix}0.25907 & - 0.57844 & - 4.8382 e - 18 \\ 0.40198 & - 0.34868 & - 1.0835 e - 16 \\ 0.27704 & - 0.26418 & - 0.70711 \\ 0.49682 & 0.44914 & - 1.4405 e - 16 \\ 0.27704 & 0.26418 & 0.70711 \\ 0.35231 & - 0.028074 & 9.1426 e - 17 \\ 0.49682 & 0.44914 & 5.2698 e - 18\end{matrix} ] .$$

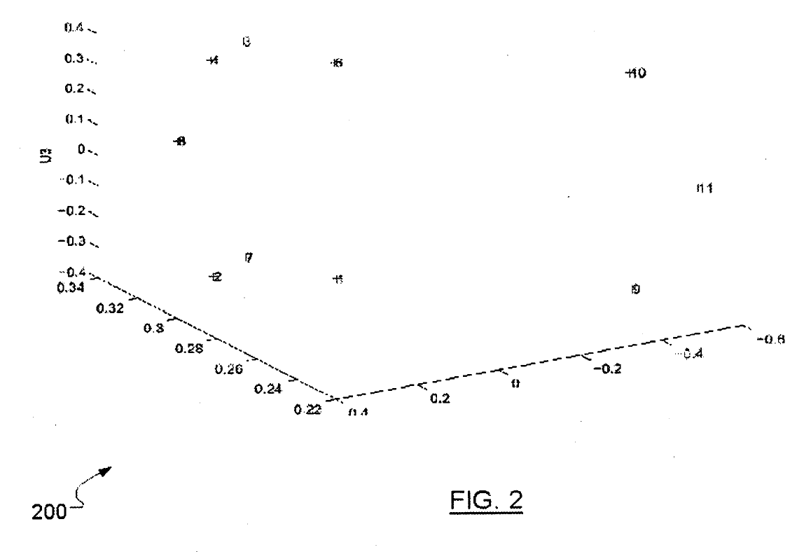

A representation of the three dimensional rows of U as points in three dimensional space is shown in FIG. 2. The points are shown by “+” symbols associated with a number indicative of the row in matrix U (and correspondingly, matrix A) that the point represents. Note that there is a clear separation between points from the two classes of traffic. Note also that the first class separates into two subclasses—in this case based on whether or not bit number 3 is a 1—and that this could be the basis for further classification.

Creating Geometric Regions

Points from the same class may now be captured geometrically. This can be done by constructing a geometric region that encloses the points of each class, or by constructing linear or non-linear separators between the classes. Exemplary geometric regions include a convex hull, which provides a tight enclosure for a set of points in the same class, and a bounding box, which provides a less rigorous enclosure, but may still cleanly separate the classes. A bounding box for a particular class of points may be defined as the smallest box that may be determined that encloses all points in the class. In three dimensions, a bounding box may be defined by six extreme coordinates defining three ranges (x₁, x₂, y₁, y₂, z₁, z₂).

It is not guaranteed that the classes will be disjoint, since this depends on the way in which the classes are chosen. It is surprising that classes drawn from Internet traffic should ever form compact regions in a low-dimensional space. The number of addresses in the Internet is extremely large and the range of possible packet headers even larger. However, further thought should convince the reader that the number of distinct packet headers encountered by even the busiest of Internet sites is a tiny fraction of those available. It has been found that, when such headers are mapped into low-dimensional space, the low-dimensional representations of the headers exhibit considerable structure.

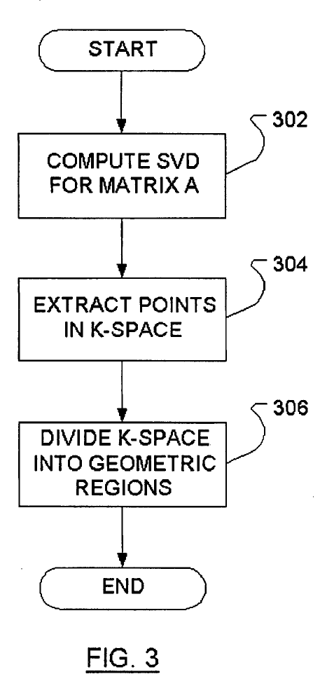

FIG. 3

FIG. 3 illustrates an algorithm whose result is a set of geometric regions for characterizing the classes of incoming packet headers. Given a set of n points (m-dimensional vectors, each representative of a single packet header) forming a matrix A, where each point has been assigned a label indicating a known class, the SVD of the n-by-m matrix A is computed (step 302) yielding matrices U, Σ and V. Vectors comprised of rows of U (that include only the first k columns) are then regarded as points in k-space (step 304). A geometric algorithm (convex hull, bounding box, linear separator, nonlinear separator) is then used to divide k-space into geometric regions, where each geometric region encloses points in a single class (step 306).

Change Over Time

The global properties of the network traffic at a particular site or subnet change over time. In particular, the classification of traffic of a particular kind may change as a result of further analysis of its contents, actions taken during the session of which it is a part, or changes in the configuration or properties of the site or subnet. In some applications this results in a need to update the geometric regions over time.

There are several ways in which this can be done. The entire SVD can be recomputed using the original data and the new data from transactions, now labeled with a known class, after their interaction with the traffic classification system 110 (FIG. 1). Thus, once several incoming packets have been classified through the transformation of at least a portion of their respective headers to points in k-space and comparing of the points to these geometric regions, the method may be repeated with a set of n+n′ points in order to recalibrate the regions (where the n points are the original points and the n′ points are the recently classified points). This gives a complete re-mapping of the spatial locations of the data, but is also expensive to compute (O(n³) in this setting). It is also possible to use an incremental SVD algorithm which provides sub-optimal mappings of points in the low-dimensional space but is much cheaper to compute. For example, the technique presented in H. Zha and H. Simon, On Updating Problems In Latent Semantic Indexing, SIAM Journal of Scientific Computing 21:782-791, 1999, computes an incremental SVD in time O(n²). The technique of J. C. Nash, Compact Numerical Methods for Computers: Linear Algebra and Function Minimization, A. Hilger, Bristol 1979, is even cheaper to compute, but is not as accurate.

Another way to compute an incremental SVD involves adding the n′ recently classified points to A, thereby yielding a new matrix A′. From new matrix A′ and previously determined matrices Σ and V, a new matrix U′ may be determined by solving for n′ new rows to add to U.

Depending on the choice of technique, the result is a new set of labeled points in a low-dimensional space. The computation of geometric regions must now be repeated for those new points.

Updating Geometric Regions

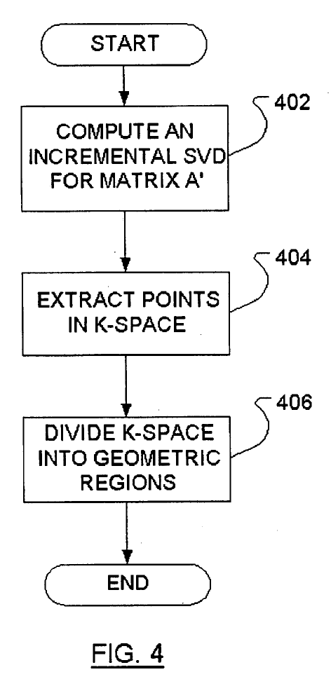

Steps of a method for updating geometric regions with an incremental SVD are presented in FIG. 4. Given the U, Σ and V matrices from an SVD performed on the original n points, and a set of n′, recently classified points, an incremental SVD may be computed (step 402) to yield a new matrix U′. The first k columns of the new matrix U′ are regarded as points in k-space (step 404). The geometric algorithm (convex hull, bounding box, linear separator, nonlinear separator) of step 306 above is repeated to divide k-space into geometric regions, where each geometric region encloses points in a single class (step 406).

Querying New Points Against Geometric Regions

Construction of a geometric representation of class structure implied by a given set of characterized points has been described. Consider now the process of evaluating a new packet header and using the previously constructed geometric regions to predict into which class new the packet header falls.

Intuitively, determining a predicted class for a packet header requires mapping the packet header into the low-dimensional space representing the known data and then determining into which region the low-dimensional point representative of the packet header falls.

The first step is to extract and weight the header bits of the new packet in exactly the same way as was done for the geometric region creation process. The extracted and weighted bits are then mapped into a point in the low-dimensional space using a querying technique based on SVD. For example, Berry and Dumais, M. W. Berry and S. T. Dumais and G. W. O'Brien, Using Linear Algebra for Intelligent Information Retrieval, SIAM Review, Vol. 37, No. 4, 1995, 573-595 (hereby incorporated herein by reference), suggest using the following equation

u=tVₖ^{T}Σₖ⁻¹

to map a 1-by-m vector, t, to a 1-by-k vector, u. This technique has been extensively tested for text retrieval, where it is known as Latent Semantic Indexing (LSI).

It is also possible to adapt an incremental SVD algorithm provided by H. Zha and H. Simon, “On updating problems in latent semantic indexing,” SIAM Journal of Scientific Computing, vol. 21, 1999, pp. 782-791 (hereby incorporated herein by reference), to give a better, but more expensive, technique for mapping from a 1-by-m vector to a 1-by-k vector. Other more expensive techniques, up to and including computing an SVD of the original data and the new point, are possible.

Once a new packet header has been mapped to a low-dimensional point, the position of the low-dimensional point in relation to the geometric regions can be determined. In the case of regions enclosing regions, this means determining whether the point falls inside or outside each region. Standard algorithms for containment in a convex hull can be used; these do not require significant computation. For the case of separators, it means determining on which side of each separator the point lies. Again, standard techniques can be used.

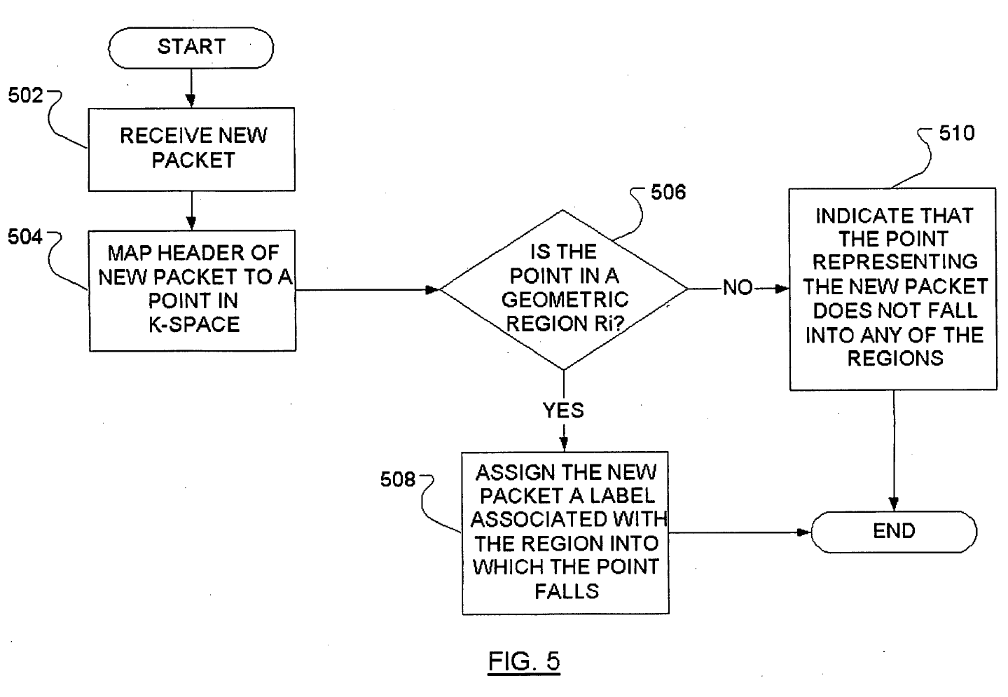

The Process is Illustrated in FIG. 5

The method whose steps are illustrated in FIG. 5 takes U, Σ and V matrices from an SVD, a set of geometric regions Rᵢ and class labels associated with each region Rᵢ as input. Initially a new packet is received (step 502). The header of the new packet is mapped to a k-dimensional point in k-space using an appropriate technique (step 504) such as discussed above. It is then determined whether the k-dimensional point falls in any of the region Rᵢ (step 506). The class label associated with the class represented by the region Rᵢ into which the point falls is then supplied as output of the method (step 508). If the entire space is not described by the regions Rᵢ and the k-dimensional point falls outside of all regions, then this condition may be indicated (step 510).

A Denial of Service Attack Can Be Characterized

A denial of service (DoS) attack is an incident in which a user or organization is deprived of the services of a resource they would normally expect to have. One of the most dangerous forms of Denial of Service attacks is a SYN Attack. Under normal circumstances a computer that initiates a communication session (an initiator) sends a TCP SYN synchronization packet to a receiving server. The receiving server sends back a TCP SYN-ACK packet and then the initiator responds with an ACK acknowledgment. After this handshake, both parties are set to send and receive data.

A SYN Attack floods a targeted system with a series of TCP SYN packets. Each TCP SYN packet causes the targeted system to issue a SYN-ACK response. While the targeted system waits for the ACK that should follow the SYN-ACK, the targeted system queues up all outstanding SYN-ACK responses on what is known as a backlog queue. This backlog queue has a finite length that is usually quite small. Once the backlog queue is full, the targeted system will ignore all incoming TCP SYN packets. SYN-ACKs are moved off the queue only when an ACK comes back or when an internal timer (which is set to a relatively long interval) terminates the three-part handshake.

A SYN Attack creates each SYN packet in the flood with a “bad” source IP address, which identifies the original packet. A source IP address is “bad” if it either does not actually exist or is down. All SYN-ACK responses are sent to the source IP address. Therefore, the ACK that should follow a SYN-ACK response will never come back. This creates a backlog queue that is always full, making it nearly impossible for legitimate TCP SYN requests to get into the system. DoS attacks early in the year 2000 disabled several major web sites.

Using a hereinafter proposed DoS detector, a DoS attack can be characterized by the appearance of similar packets within a time-frame that is too short for them to have been generated by normal activity. In practice, a threshold value may be established for each newly detected intrusion in the DoS detector for the purpose of detecting DoS attacks before the attacks disable the systems of the local subnet 116 (FIG. 1).

We can use an initial SVD to establish a mapping to low-dimensional space, but in this embodiment of the present invention, the geometric regions are determined by ongoing packet arrivals, rather than from the k-dimensional points extracted from the matrix U in the initial SVD. Each packet may be considered as creating a sphere of given diameter around its low-dimensional position. Newer points may be tested to see if they fall into any existing sphere. If more than a given number of points are found in the same sphere, the system may be undergoing a DoS attack. The spheres themselves may be allowed to disappear after a given period of time. This can only be achieved due to the fast detection we enjoy using the SVD detection model.

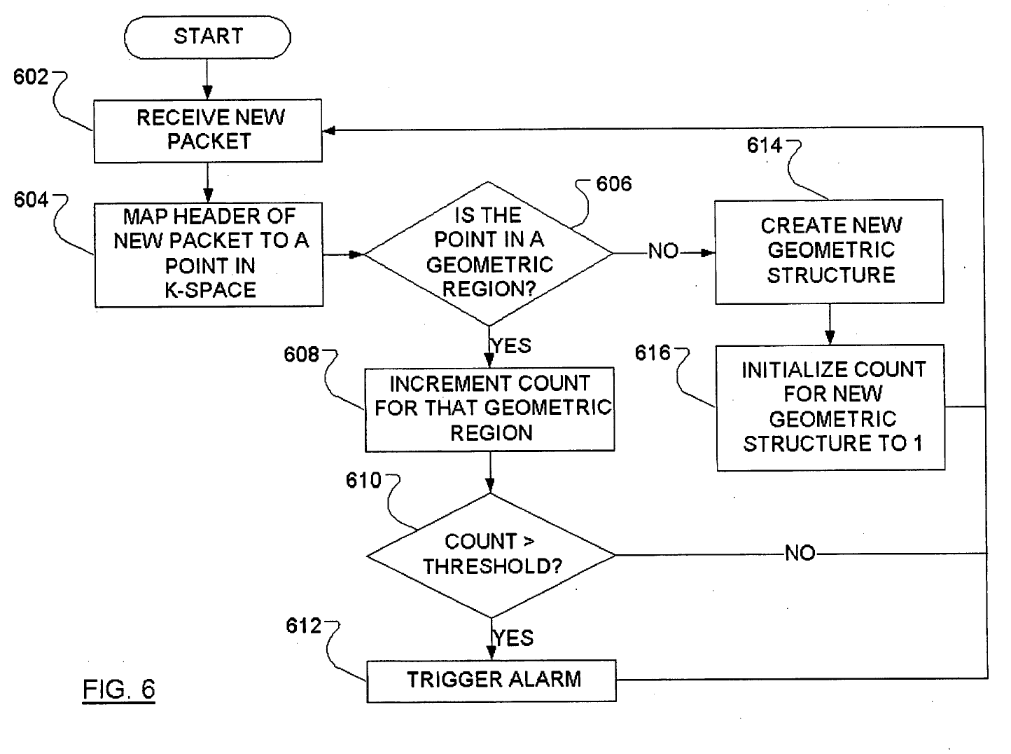

FIG. 6

The method of operation of the DoS detector is detailed in FIG. 6. Given U, Σ and V matrices from an SVD of a training set of packets, a new packet is received (step 602). The new packet header may then be mapped to a point in k-space (step 604) using methods described hereinbefore. It is then determined whether the newly mapped point falls into an existing geometric region (step 606). If the newly mapped point does fall into an existing geometric region, a count for that geometric region is incremented (step 608). If it is determined that the count exceeds a given threshold (step 610), an alarm may be triggered (step 612). If the newly mapped point does not fall into an existing geometric region, a new geometric region is created (step 614) and a count associated with the new geometric region is initialized to one (step 616). Additionally, a count down timer for each region is initialized when the region is created. Whenever a newly mapped point falls into a given region, the count down timer for the given region is re-initialized. If a count down timer for a region times out, the region is deleted.

In Operation

We have implemented intrusion detection embodiments of the present invention using data collected by a group led by Dr. Forrest at the University of New Mexico. For an indication of the work performed by the Forrest group, see Hofmeyr, S. A. & Forrest, S. (1999), “Immunity by Design: An Artificial Immune System”, Proc. of GECCO'99, pp. 1289-1296. The Forrest data was collected with intrusion detection in mind. Packet headers were collected for a month, producing 143 MB of data from 1,448,629 packets. Among these packets there were 3900 unique packet headers.

We reduced the headers of these packets to 49 bits by (a) using only the 8-bit address for the local address, (b) reducing some ranges of port numbers to a single value, (c) adding a direction bit (inward/outgoing).

The low-dimensional region was divided into two regions, with a first region representing normal traffic and a second region, essentially everything outside the first region, representing abnormal traffic.

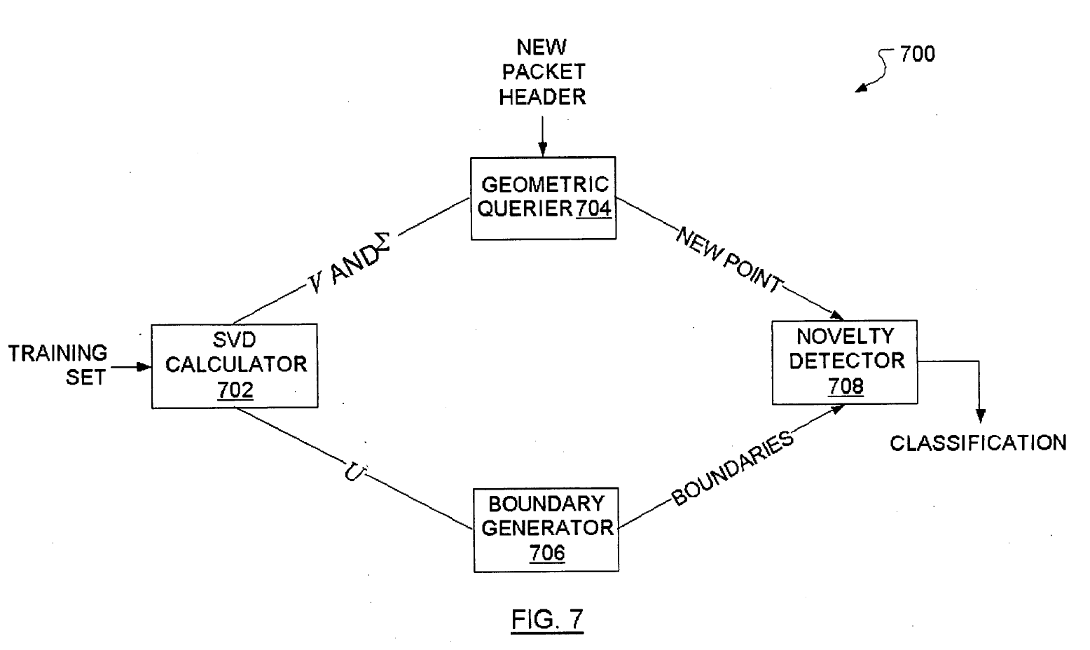

Architecture for a generic SVD detector 700 is illustrated in FIG. 7. The detector 700 includes an SVD calculator 702, a boundary generator 706, a geometric querier 704 and a novelty detector 708.

We implemented the SVD calculator 702 in C and employed a common singular value decomposition process (a macro program for computing SVDs is also available in MATLAB™ software packages). As shown, the input to the SVD calculator 702 is a set of normal packets and a set of known abnormal packets. The output of the SVD calculator 702 is the matrices U, Σ and V. These matrices are provided to the boundary generator 706 and the geometric querier 704.

The boundary generator 706 was written in C as well and generated a loose, less rigorous, but cheaper bounding box as an outer boundary and a tighter, more accurate, but more computationally expensive convex hull as an inner boundary, to enclose a set of points that belong to the same class in a three dimensional space. The bounding box was constructed using the extreme coordinates in six directions (i.e., two along the x-axis, two along the y-axis and two along the z-axis) of its input data set. The convex hull was constructed using a software package named Qhull, which implements a high-quality, robust, and user-friendly process for computing a convex hull in any dimension. Qhull is available at http://www.geom.umn.edu/software/qhull. The process used in Qhull originates from the Quickhull process that may be found in J. O'Rourke, Computational Geometry in C, Cambridge University Press, 2nd Edition, 1998, herby incorporated herein by reference.

The geometric querier 704 exploited the SVD query process and was also coded in C. The geometric querier 704 takes as input a new compressed header and a set of V and Σ matrices from the SVD calculator 702. The geometric querier 704 output is a (k=) three dimensional point representing the position of the new header in the space based on the singular value decomposition performed by the SVD calculator 702.

The novelty detector 708 uses the bounding box and the convex hull that were constructed earlier and supplied to the novelty detector 708 by the boundary generator 706. The language used to implement the novelty detector 708 was also C. Checking a bounding box is much faster than checking a convex hull when determining if a point falls outside the enclosed region. It was thus used as the first line of defense. The testing involved comparing the coordinate of the new point to the six extreme coordinates of the bounding box. If the point was found to be inside the box, it had then to be tested against the more expensive but also more accurate convex hull. The method used for testing a point against a three dimensional convex hull is known as the Ray Crossing method. The logic behind the ray-crossing process in three dimensions is: a point q is inside convex hull P iff a ray from q to infinity crosses the boundary of P an odd number of times. A ray to infinity can be effectively simulated by a long segment, longer than the largest extent of the convex hull (J. O'Rourke, Computational Geometry in C, cited above).

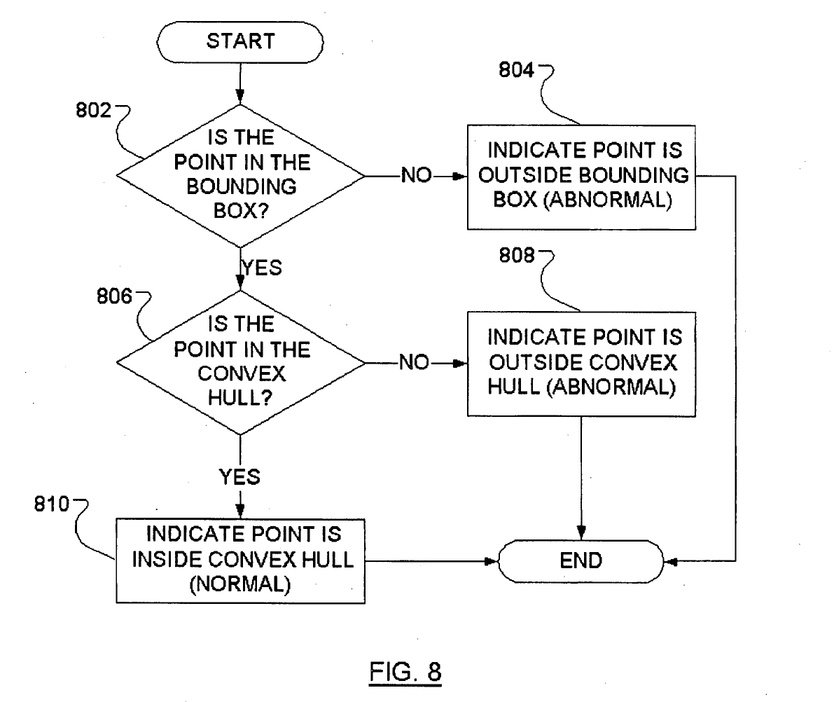

The staged approach taken above at the exemplary novelty detector 708 is illustrated in FIG. 8. In preparation for the steps of FIG. 8, the SVD calculator 702 queries the memory 120 (FIG. 1) and receives a set of training data. The SVD calculator 702 then decomposed the set of training data and the matrices resulting from the decomposition were used by the boundary generator 706 to generate a bounding box and a convex hull. A new packet was received at the geometric querier 704 and the header of that packet was mapped to a new traffic point in k-space. It was then determined whether the new traffic point fell outside the bounding box (step 802). If the new traffic point fell outside the bounding box, a flag was returned (step 804) indicating that the new traffic point fell outside the bounding box, and thus the packet was “abnormal”. If the new traffic point fell inside the bounding box, the new traffic point was checked again (step 806) to determine if the new traffic point fell within the convex hull. If the new traffic point did not fall within the convex hull, a flag was returned (step 808) indicating that the new traffic point fell outside the convex hull, and thus the packet was “abnormal”. If the new traffic point fell within the convex hull, a flag was returned (step 810) indicating that the new traffic point fell inside the convex hull, and thus the packet was “normal”. This staged approach provides a rudimentary indication of confidence since some points are more abnormal than others.

A further stage may be added to the staged approach of FIG. 8. The boundary generator 706 may also supply an inner bounding box that does not bound the training points, but can be placed entirely within the convex hull. This is in contrast to the original (outer) bounding box, which entirely encloses the convex hull. Points representative of intrusions are likely to fall outside the outer bounding box and points representative of normal traffic are likely to fall inside the inner bounding box. When a given point falls either outside the outer bounding box or inside the inner bounding box, the more expensive check against the convex hull is not necessary. This approach provides significant performance optimizations, since the great majority of new traffic points fall inside the inner bounding box.

Detection rates are greatly improved if the low-dimensional space is constructed using normal traffic and a sample of abnormal traffic. Choosing different abnormal traffic for the sample results in different low-dimensional spaces.

Each low-dimensional space has this in common: normal traffic always maps into (or very close to) the normal region, while abnormal traffic may, on occasion, also map into the normal region for some low-dimensional spaces, abnormal traffic tends to fall further and further from the normal region the more it resembles known abnormal traffic.

Therefore the following staged process may be used. A set of low-dimensional spaces and normal traffic regions are constructed, each one using the same normal traffic and a different set of abnormal traffic. A new packet header is mapped into each low-dimensional space separately. The new packet is classified as normal only if it falls into the normal region in all of the low-dimensional spaces. Thus, a point that falls outside the normal region in any of the low-dimensional spaces is classified as an intrusion.

The sets of abnormal traffic can be generated from an initial, known intrusion by manipulating the bits of the external addresses to make them as different as possible. For example, these address bits can be complemented to create an artificial intrusion that is from the “opposite direction” to the initial intrusion.

In general, different processes can be used to combine the results of region determination from sets of low-dimensional spaces. The discussion above assumed a one-sided winner-take-all combination. Plurality voting is another possibility which might be more sensible when there are more than two regions.

In general, an interaction or communication session involves many packets. For the more complex communication sessions, it might take several packets to establish a set of parameters for the session. As will be apparent to a person skilled in the art, the present invention may be adapted to use some or all of this parametric information, and is not necessarily limited to packet headers.

As will also be apparent to a person skilled in the art, SVD may not be the only method for transforming points in a high dimensional space into a much lower dimensional space. For instance, it is known that Principle Component Analysis (PCA) can be used to reduce a vector dimension, while retaining most of the information, by constructing a linear transformation matrix.

Other modifications will be apparent to those skilled in the art and, therefore, the invention is defined in the claims.

We claim:

1. A method to facilitate classification of packetized traffic, comprising:
considering at least a portion of a header of each of a training set of packets as an m-dimensional vector; and
reversibly transforming each said m-dimensional vector to a r-dimensional vector, where r≦m, and where an element of a given r-dimensional vector having a lower element number is more significant in differentiating said given r-dimensional vector from other r-dimensional vectors obtained from said training set than an element associated with a higher element number of said given r-dimensional vector such that said given r-dimensional vector is substantially defined with respect to said other r-dimensional vectors by its first k elements.

2. The method of claim 1 wherein said training set yields n m-dimensional vectors and wherein said reversibly transforming comprises creating an n-by-m matrix, A, from said m-dimensional vectors and determining a singular value decomposition (“SVD”) of said matrix A as a product of three matrices U, Σ, and V.

3. The method of claim 2 further comprising creating a k-dimensional vector from said first k elements of each said r-dimensional vector.

4. The method of claim 3 further comprising creating a region in k-dimensional space containing a sub-set of said k-dimensional vectors which sub-set corresponds to m-dimensional vectors corresponding to packet headers of said training set having a pre-defined classification.

5. The method of claim 4 wherein said matrix U is an n-by-r matrix comprising said r-dimensional vectors.

6. The method of claim 5 further comprising:
receiving a packet to be classified;
considering at least a portion of a header of said received packet as a received m-dimensional vector; and
reversibly transforming said received m-dimensional vector to a received r-dimensional vector utilizing said matrices Σ and V.

7. The method of claim 6 further comprising creating a received k-dimensional vector from said first k elements of each said received r-dimensional vector and determining whether said received k-dimensional vector is within said region.

8. The method of claim 2 further comprising, repetitively:
receiving a packet;
considering at least a portion of a header of said received packet as a received m-dimensional vector;
utilizing said SVD, reversibly transforming said received m-dimensional vector to a received r-dimensional vector;
creating a received k-dimensional vector from said first k elements of said received r-dimensional vector; and
if said received packet does not lie in an existing region in k-dimensional space, creating a region in k-dimensional space based on said received k-dimensional vector.

9. The method of claim 8 further comprising, if said received packet does lie in a given existing region in k-dimensional space, incrementing a count of received packets for said given existing region.

10. The method of claim 9 further comprising indicating if a count of received packets for said given existing region exceeds a pre-determined count within a pre-determined time.

11. A traffic classification system comprising:
means for considering at least a portion of a header of each of a training set of packets as an m-dimensional vector; and
means for reversibly transforming each said m-dimensional vector to a r-dimensional vector, where r≦m, and where an element of a given r-dimensional vector having a lower element number is more significant in differentiating said given r-dimensional vector from other r-dimensional vectors obtained from said training set than an element associated with a higher element number of said given r-dimensional vector such that said given r-dimensional vector is substantially defined with respect to said other r-dimensional vectors by its first k elements.

12. A computer readable medium containing computer-executable instructions which, when performed by a processor in a traffic classification system, cause the processor to:
consider at least a portion of a header of each of a training set of packets as an m-dimensional vector; and
reversibly transform each said m-dimensional vector to a r-dimensional vector, where r≦m, and where an element of a given r-dimensional vector having a lower element number is more significant in differentiating said given r-dimensional vector from other r-dimensional vectors obtained from said training set than an element associated with a higher element number of said given r-dimensional vector such that said given r-dimensional vector is substantially defined with respect to said other r-dimensional vectors by its first k elements.

13. A method of classifying a received packet comprising:
considering at least a portion of a header of said received packet as a received m-dimensional vector;
reversibly transforming said received m-dimensional vector to a received r-dimensional vector;
creating a received k-dimensional vector from said first k elements of each said received r-dimensional vector; and
determining whether said received k-dimensional vector is within a first predefined k-dimensional region.

14. The method of claim 13 further comprising, if said received k-dimensional vector is within said first predefined k-dimensional region, assigning a classification to said received packet, where said classification is associated with said first predefined k-dimensional region.

15. The method of claim 13 further comprising, if said received k-dimensional vector is outside of said first predefined k-dimensional region, assigning a classification to said received packet, where said classification is associated with a second region, defined as a region, in said k-dimensional space, outside said first predefined k-dimensional region.

16. The method of claim 13 further comprising, determining whether said received k-dimensional vector is within a second predefined k-dimensional region and, if said received k-dimensional vector is within said first predefined k-dimensional region and said second predefined k-dimensional region, assigning a classification to said received packet, where said classification is associated with both of said first and second predefined k-dimensional regions.

17. A traffic classification system comprising:
means for considering at least a portion of a header of said received packet as a received m-dimensional vector;
means for reversibly transforming said received m-dimensional vector to a received r-dimensional vector;
means for creating a received k-dimensional vector from said first k elements of each said received r-dimensional vector, and
means for determining whether said received k-dimensional vector is within a first predefined k-dimensional region.

18. A computer readable medium containing computer-executable instructions which, when performed by a processor in a traffic classification system, cause the processor to:
consider at least a portion of a header of said received packet as a received m-dimensional vector;
reversibly transform said received m-dimensional vector to a received r-dimensional vector;
create a received k-dimensional vector from said first k elements of each said received r-dimensional vector; and
determine whether said received k-dimensional vector is within a first predefined k-dimensional region.

19. A method of classifying a received packet comprising:
considering at least a portion of a header of said received packet as a received m-dimensional vector;
transforming said received m-dimensional vector to a received k-dimensional vector;
determining whether said received k-dimensional vector is within an existing predefined k-dimensional region; and
if said received k-dimensional vector is within a first predefined k-dimensional region, incrementing a first counter, said first counter associated with said first predefined k-dimensional region.

20. The method of claim 19 wherein, if said received k-dimensional vector is outside any predefined k-dimensional region,
defining a new k-dimensional region based on said received k-dimensional vector; and
initializing a new counter, said new counter associated with said new k-dimensional region.

21. The method of claim 19 further comprising, where a count maintained by said first counter surpasses a predetermined threshold, triggering an alarm.

22. A traffic classification system comprising:
means for considering at least a portion of a header of said received packet as a received m-dimensional vector;
means for transforming said received m-dimensional vector to a received k-dimensional vector,
means for determining whether said received k-dimensional vector is within an existing predefined k-dimensional region; and
if said received k-dimensional vector is within a first predefined k-dimensional region, means for incrementing a first counter, said first counter associated with said first predefined k-dimensional region.

23. A computer readable medium containing computer-executable instructions which, when performed by a processor in a traffic classification system, cause the processor to:
consider at least a portion of a header of said received packet as a received m-dimensional vector;
transform said received m-dimensional vector to a received k-dimensional vector;
determine whether said received k-dimensional vector is within an existing predefined k-dimensional region; and
if said received k-dimensional vector is within a first predefined k-dimensional region, increment a first counter, said first counter associated with said first predefined k-dimensional region.

24. A traffic classification system comprising:
a singular value decomposition calculator for transforming a matrix A of training data, which has been classified to result in training data classifications, into component matrices U, Σ and V,
a boundary generator for, given said matrix U and said training data classifications, generating a boundary in a k-dimensional space;
a geometric querier for, given said matrices Σ and V and received packet parameters, generating a point in said k-dimensional space; and
a detector for determining whether said point in said k-dimensional space is inside said boundary in said k-dimensional space and indicating a result of said determining.

25. The traffic classification system of claim 24 further comprising a memory for storing said matrix A of training data and where said singular value decomposition calculator is further for querying said memory to receive said matrix A of training data and receiving said matrix A of training data from said memory.

26. A computer readable medium containing computer-executable instructions which, when performed by a processor in a traffic classification system, cause the processor to:
transform a matrix A of training data, which has been classified to result in training data classifications, into component matrices U, Σ and V;
generate a boundary in a k-dimensional space, given said matrix U and said training data classifications;
generate a point in said k-dimensional space, given said matrices Σ and V and received packet parameters;
determine whether said point in said k-dimensional space is inside said boundary in said k-dimensional space; and
indicate a result of said determining.

27. A traffic classification system comprising:
means for transforming a matrix A of training data, which has been classified to result in training data classifications, into component matrices U, Σ and V;
means for, given said matrix U and said training data classifications, generating a boundary in a k-dimensional space;
means for, given said matrices Σ and V and received packet parameters, generating a point in said k-dimensional space; and
means for determining whether said point in said k-dimensional space is inside said boundary in said k-dimensional space and indicating a result of said determining.

28. A device for facilitating classification of traffic comprising:
a memory for storing a training set of packets; and
a processor, coupled to said memory, for:
considering at least a portion of a header of each of said training set of packets as an m-dimensional vector; and
reversibly transforming each said m-dimensional vector to a r-dimensional vector, where r≦m, and where an element of a given r-dimensional vector having a lower element number is more significant in differentiating said given r-dimensional vector from other r-dimensional vectors obtained from said training set than an element associated with a higher element number of said given r-dimensional vector such that said given r-dimensional vector is substantially defined with respect to said other r-dimensional vectors by its first k elements.
